(19) United States
(12) Patent Application Publication
(10) Pub. No.: US 2016/0084432 A1
(43) Pub. Date: Mar. 24, 2016

(54) SELF-POSITIONABLE LIFTING DEVICE

(71) Applicant: KELLY INTERNATIONAL CORP., Taipei City (TW)

(72) Inventor: Min-Lon CHUANG, Taipei City (TW)

(73) Assignee: KELLY INTERNATIONAL CORP., Taipei City (TW)

(21) Appl. No.: 14/717,252

(22) Filed: May 20, 2015

(30) Foreign Application Priority Data
Sep. 23, 2014 (TW) 103216824

(51) Int. Cl. F16M 11/38; F16M 13/02

(52) U.S. Cl. CPC F16M 11/38; F16M 13/022; F16M 2200/04; F16M 2200/06

(57) ABSTRACT

A self-positionable lifting device includes a linkage that has mutually parallel first and second links. The first and second links each have two ends thereof pivotally connected to a loading component and a loading platform set, respectively, so that pivotally connected points connecting the first link and the second link to the loading component and the loading platform set jointly define a parallelogramic area. The self-positionable lifting device further includes a damping mechanism that has a damper and a switch. The damper is provided between the linkage and loading component. The switch controls the damper to extend or retract by means of a control cord, the loading platform set can horizontally move in multiple directions with respect to the loading component as a result of relative pivotal movements between the first and second links. After adjustment, the loading platform set can be positioned.

### BACKGROUND OF THE INVENTION

1. Technical Field

The present invention relates to a self-positionable lifting device, which can be controlled to vertically extend/retract and revolve, and can retain itself at a post-adjustment position automatically.

2. Description of Related Art

An office chair with a gas cylinder is an example for devices that have a simple lifting mechanism that allows easy altitudinal adjustment. In a conventional office chair, a seat is connected to a caster-equipped base through a pneumatic device. The pneumatic device is operated by a switch to place the seat at different altitudes that meets various needs in use. However, such a structure can only realize altitudinal adjustment, and does not support displacement in other directions (such as forward/backward or leftward/right displacement), making its use limited.

There is also a mechanism having a post (or a plurality of links) connected to a loading platform (for receiving a keyboard and a monitor) through at least one pneumatic element (such as a gas cylinder). It is such designed that the support force form the pneumatic element is slightly greater than the overall weight of the loading platform (plus the keyboard and the monitor), so that after the loading platform (plus the keyboard and the monitor) is adjusted to a desired position, it is held at that position and a balanced posture of the whole mechanism is formed. While this structure allows altitudinal and positional adjustment depending on the characteristics of the used post (or the plural links), the balance between the loading platform and the pneumatic element tends to be broken by external force (such as that from a user's palms pressing loading platform when operating a keyboard placed on the) in practical use, making it inconvenient to use.

In view of the shortcomings of the known lifting devices, the inventor of the present invention has made improvements thereto and creates the present invention.

### SUMMARY OF THE INVENTION

The primary objective of the present invention is to provide a self-positionable lifting device, which has a linkage supporting between a preset loading component and a loading platform set, and a damping mechanism located between the linkage and the loading component, so that with the damping mechanism that can be controlled to extend or retract, and can automatically position the linked structure after operation, the loading platform set can be well positioned at its post-adjustment position.

Another objective of the present invention is to provide a self-positionable lifting device, which can have the damping mechanism and the linkage arranged between different loading components and loading platform sets as needed, so as to improve the application of the device and add value to the final products using the same.

Still another objective of the present invention is to provide a self-positionable lifting device, which use the linkage as well as the loading component and the loading platform set to form a linked structure that is parallelogramic, so that the loading platform set can be freely moved upward/downward, forward/backward, or rightward/leftward in a certain angular area, while remaining horizontal, thereby providing convenient use.

Yet another objective of the present invention is to provide a self-positionable lifting device, which can further work with a revolver so that the loading platform set is allowed to perform rotation in both directions in addition to relative movements, thereby improving its convenience in use.

To achieve the foregoing objectives and effects, the present invention implements the following technical scheme: a loading component, being locally provided with a joint; a loading platform set, having a joint; a linkage, including a first link and a second link that are parallel to each other, in which the first and second links each have one end pivotally connected to the joint of the loading component, and each have an opposite end pivotally connected to the joint of the loading platform set, so that pivotally connected points connecting the first link and the second link to the loading component and the loading platform set jointly define a parallelogramic area; and a damping mechanism, including a damper and a switch, in which the damper is provided between the linkage and the loading component, and is connected to the switch via a control cord, so that when the switch is pushed, the damper is driven to extend or retract, and in turn makes the loading platform set horizontally move forward/backward and upward/downward with respect to the loading component in virtue of relative pivotal movements between the first and second links, and when the switch is released, the damper is prevented from extending or retracting.

Thereby, the damper serves to provide proper support to the loading platform set in accordance with the total load born by the loading platform set so as to form balance. In addition, the switch controls the damper to extend or retract or get locked from extending or retracting. A user can easily move the loading platform set by pressing the switch an applying a minor force to reposition the loading platform set to a desired position. During the movement, the user does not need to hold and bear the loading platform set, and when moved to the desired position, the loading platform set can be easily positioned by the user's releasing the switch which locks the damper. The loading platform set is thus secured from being moved under external force, thereby significantly improving convenience in use.

In the configuration discussed above, the loading component is provided with a first pivot seat, and the first link is provided with a second pivot seat, so that the damper has two ends thereof pivotally connected to the first and second pivot seats, respectively.

In the configuration discussed above, the loading component is a base, and the first pivot seat is deposited on the base.

In the configuration discussed above, the loading component includes a guiding post, a revolver, and a retainer, in which the revolver and the retainer are mounted around a middle part of the guiding post, while the retainer is located below the revolver, so that the revolver is retained at a predetermined altitude on the guiding post by the retainer and is allowed to freely pivot, and in which the first pivot seat is deposited on the revolver.

In the configuration discussed above, the guiding post has one end thereof provided with a clamp that is configured to hold an external article or table and position the self-positionable lifting device with respect to the article or table.

In the configuration discussed above, the loading platform set has a pivotal connector that is connected to both of the first and second links, and has a pivotable support, in which the pivotal connector has a pivotal shaft that is posed parallel to the guiding post, and the pivotable support has a connector is pivotally mounted around the pivotal shaft, so that by rotating the connector with respect to the pivotal shaft, the loading platform set is moved forward/backward, leftward/rightward and/or upward/downward respect to the loading component in a limited range.

In the configuration discussed above, the pivotable support has a middle part thereof provided with an adjustable holder that is configured to move along and get positioned on the pivotable support, and a mount is pivotally connected to the adjustable holder.

In the configuration discussed above, wherein the loading platform set includes a first loading platform and a second loading platform that are mutually connected by an extension support.

In the configuration discussed above, the switch is provided at one side of the second loading platform.

In the configuration discussed above, the first and second loading platforms are parallel to each other and have an altitudinal difference therebetween.

The invention as well as a preferred mode of use, further objectives and advantages thereof will be best understood by reference to the following detailed description of illustrative embodiments when read in conjunction with the accompanying drawings.

### BRIEF DESCRIPTION OF THE DRAWINGS

FIG. 1 is a perspective view of a first embodiment of the present invention.

FIG. 2 is a schematic side view of the first embodiment of the present invention, showing that it is positioned at a high position.

FIG. 3 is a schematic side view of the first embodiment of the present invention, showing that it is positioned at a low position.

FIG. 4 is a perspective view of a second embodiment of the present invention.

FIG. 5 is a schematic side view of the second embodiment of the present invention, showing that it is positioned at a low position.

FIG. 6 is a schematic side view of the second embodiment of the present invention, showing that the second loading platform is folded upward.

FIG. 7 is a schematic side view of the second embodiment of the present invention, showing that it is positioned at a high position.

FIG. 8 is a top view of the second embodiment of the present invention.

FIG. 9 is another top view of the second embodiment of the present invention, showing that it sways to one side.

### DETAILED DESCRIPTION OF THE INVENTION

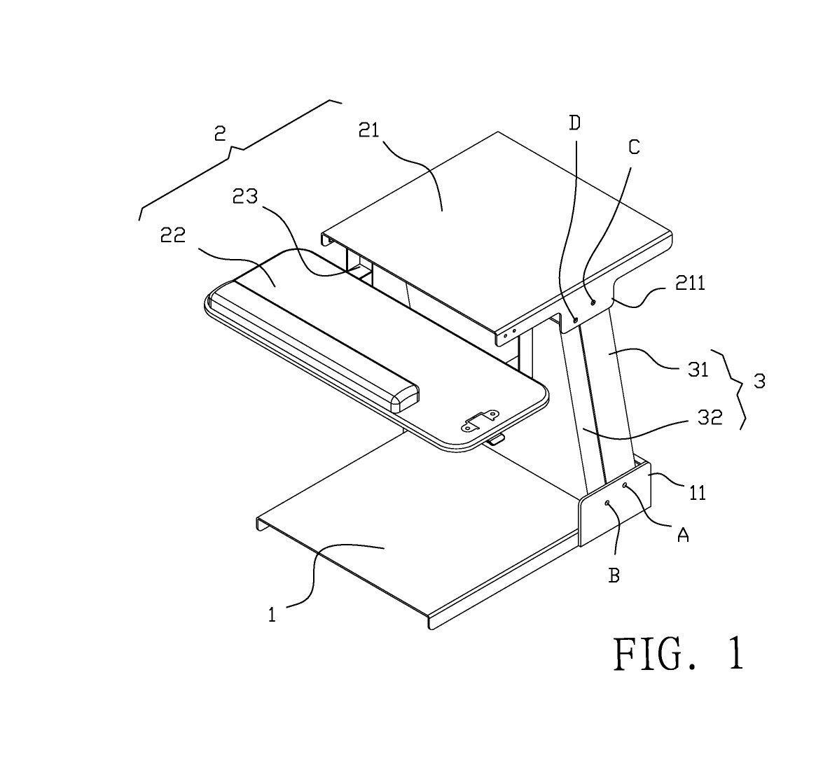

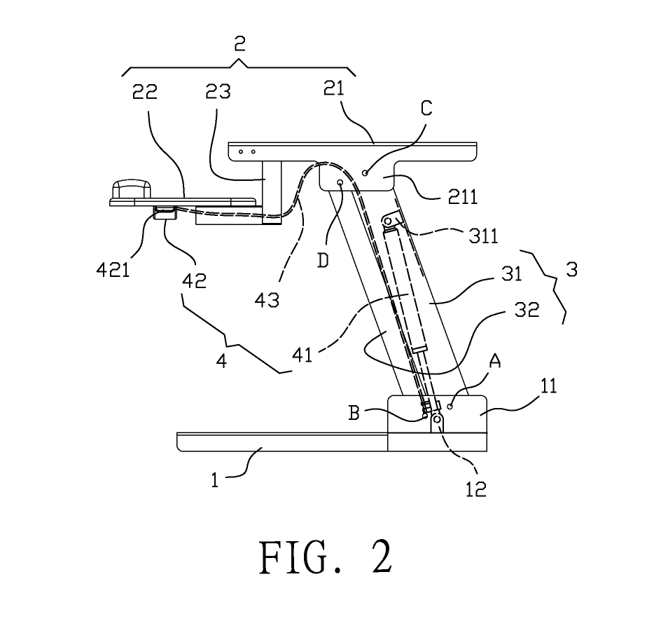

Referring to FIGS. 1 and 2, according to the first embodiment of the present invention, the disclosed mechanism comprises: a loading component 1, a loading platform set 2, a linkage 3, and a damping mechanism 4. Therein, the loading component 1 is locally provided with a joint 11, and the joint 11 contains therein a first pivot seat 12.

In the present embodiment, the loading component 1 is a flat base, which can be stably placed on a predetermined plane, and the joint 11 and the first pivot seat 12 are installed on the base.

The loading platform set 2 is composed of a first loading platform 21 and a second loading platform 22. The first and second loading platform 21, 22 are connected to each other by means of an extension support 23, so that the first and second loading platforms 21, 22 are mutually parallel and have an altitudinal difference therebetween. The first loading platform 21 is provided with a joint 211.

The linkage 3 is composed of a first link 31 and a second link 32 that are parallel to each other. The first and second links 31, 32 each have one end pivotally connected to the joint 11 of the loading component 1 by means of a pin A or B, and each have an opposite end pivotally connected to the joint 211 of the loading platform set 2 by means of a pin C or D, so that the corresponding ends of the pins A, B, C and D jointly define a parallelogramic area. The first link 31 is provided with a second pivot seat 311.

In the present embodiment shown in the drawings, the first and second links 31, 32 are telescoped, so as to eliminate the risk of mutual interference therebetween in practical operation.

The damping mechanism 4 is composed of a damper 41 (that may be a gas cylinder with locking function) and a switch 42. The damper 41 is pivotally connected between the second pivot seat 311 of the first link 31 and the first pivot seat 12 of the loading component 1, and the damper 41 is connected to the switch 42 by means of a control cord 43. The switch 42 may be placed at one side of the second loading platform 22 and may have an operatable paddle 421. When the paddle 421 is operated, the switch 42 controls the damper 41 to allow it to extend or retract in response to an external force. When the paddle 421 is released, the damper 41 locks itself from extending and retracting.

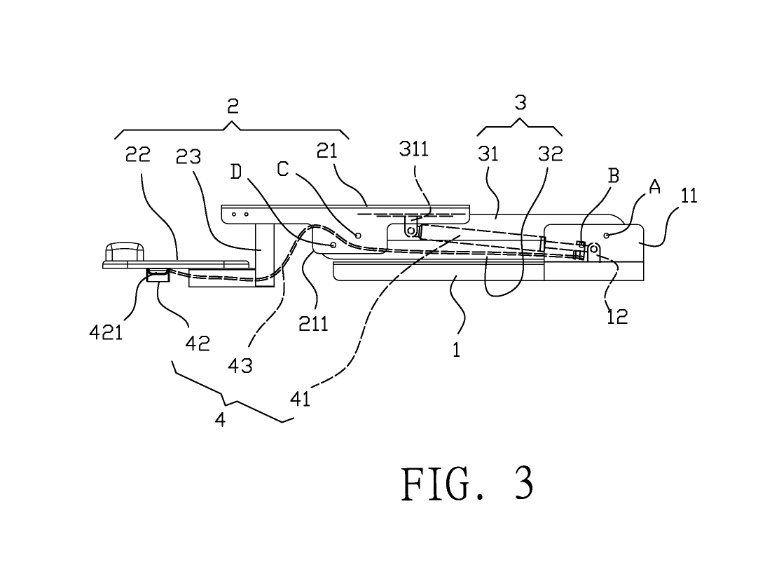

Referring to FIG. 3, according to the first embodiment of the present invention, during the positional adjustment, when the paddle 421 is operation, the second loading platform 22 can be pushed or pressed at the same time by an operator, so that the loading platform set 2 drives the first and second links 31, 32 to rotate relatively. Throughout the process of the rotation, the imaginary line connecting the pins C and D remains parallel to the imaginary line connecting the pins A and B (holding the parallelogramic area), so the loading platform set 2 is restricted to move forward/backward and upward/downward while remaining parallel to the loading component 1. With the pivotal movement of the first link 31, the damper 41 receives force and is driven to extend or retract.

When the loading platform set 2 moves to a desire position, the operator may release the paddle 421, so that the damper 41 is locked and prevented from extending and retracting, making the loading platform set 2 positioned. Thereby, even if the loading platform set 2 (the first and second loading platforms 21 and 22) receives external force (such as that from a user's palms pressing the second loading platform 22 when operating a keyboard placed on the second loading platform 22), it is unlikely to have unintentional displacement, making its use more convenient.

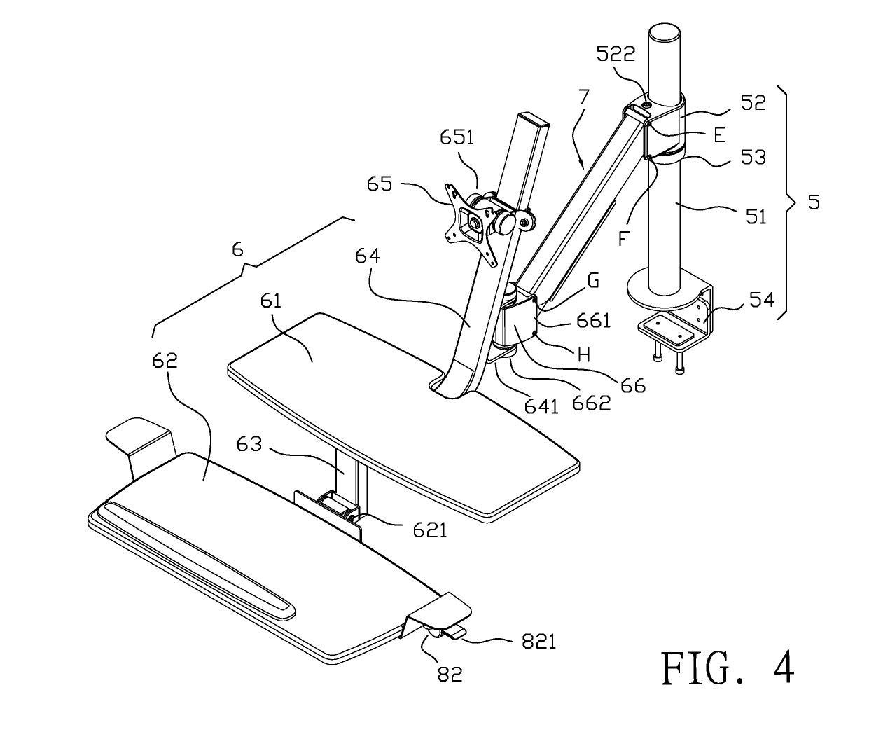

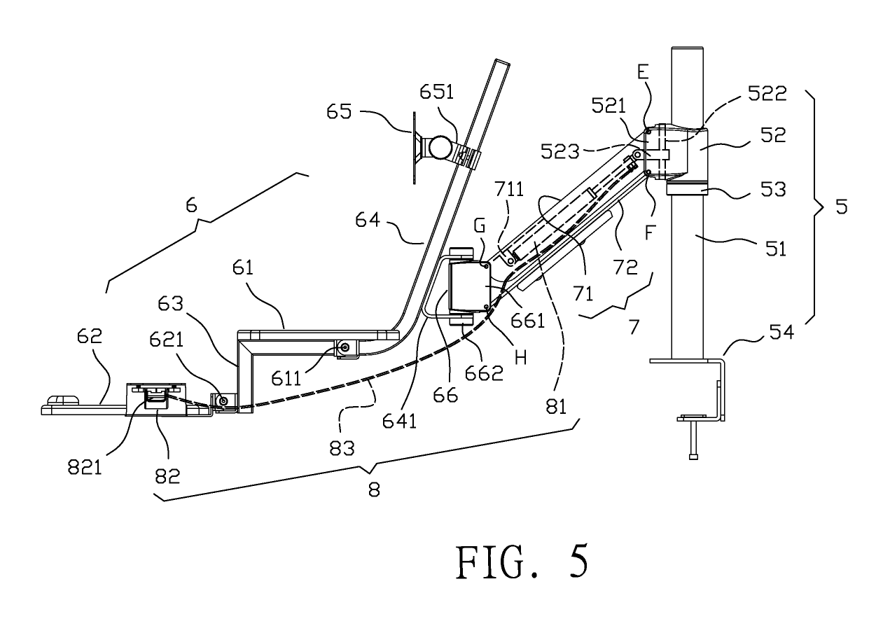

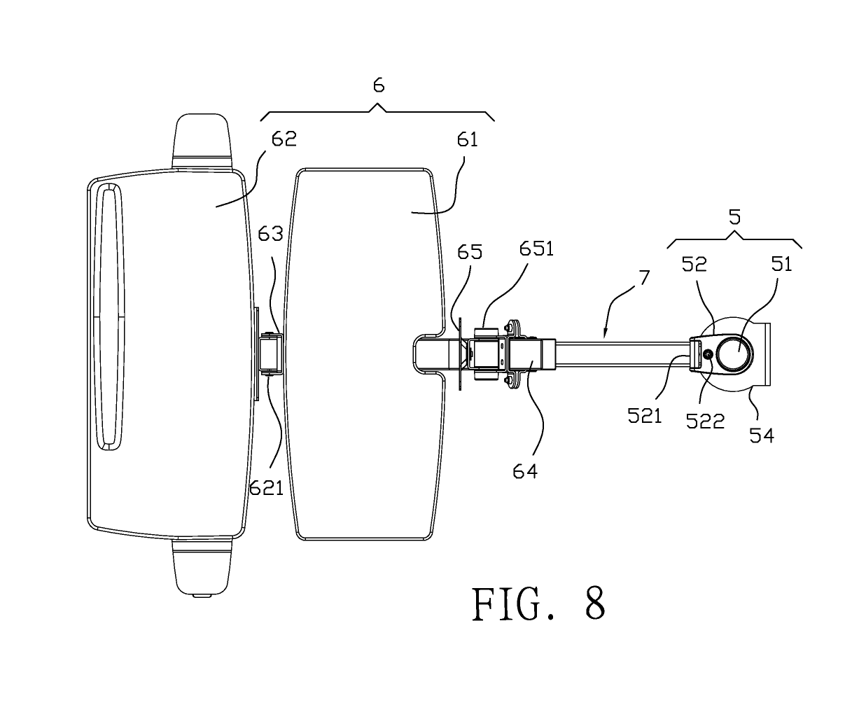

Referring to FIGS. 4, 5 and 8, according to the second embodiment of the present invention, the disclosed mechanism comprises: a loading component 5, a loading platform set 6, a linkage 7 and a damping mechanism 8. Therein, the loading component 5 is composed of a guiding post 51, a revolver 52 and a retainer 53. The guiding post 51 has its one end provided with a clamp 54 configured to hold an external article or table and position the self-positionable lifting device with respect to the article or table. The revolver 52 and the retainer 53 are mounted around the middle part of the guiding post 51, and the retainer 53 is fixed below the revolver 52. With the retaining force from the retainer 53, the revolver 52 is rotatably positioned at the set altitude on the guiding post 51. The revolver 52 has a joint 521 and an inner pivot 522, and a first pivot seat 523 is pivotally connected to the inner pivot 522.

The loading platform set 6 is composed of a first loading platform 61, a second loading platform 62, a pivotable support 64 and a pivotal connector 66. The first and second loading platforms 61 and 62 are mutually connected by means of an extension support 63, so that the first and second loading platforms 61 and 62 are parallel to each other and have an altitudinal difference therebetween.

The pivotal connector 66 has a joint 661 and a pivotal shaft 662 parallel to the guiding post 51. The pivotable support 64 has its one end connected to the first loading platform 61 (or the second loading platform 62). At the middle part of the pivotable support 64, a connector 641 and an adjustable holder 651 are provided. The connector 641 is pivotally mounted around the pivotal shaft 662, and the adjustable holder 651 is adjustablty fixed to the middle part of the pivotable support 64. The adjustable holder 651 is pivotally provided with a mount 65 that is configured to hold an external device (such as an LCD).

In a feasible embodiment, the first loading platform 61 is pivotally connected to the terminal of the pivotable support 64 by means of a first pivot 611. The extension support 63 may be combined with the first loading platform 61. The second loading platform 62 is pivotally connected to the terminal of the extension support 63 by means of a second pivot 621.

The linkage 7 is composed of a first link 71 and a second link 72 that are parallel to each other. The first and second links 71 and 72 each have one end pivotally connected to the joint 521 of the loading component 5 by means of a E or F, and each have an opposite end pivotally connected to the joint 661 of the loading platform set 6 by means of a pin G or H. The corresponding ends of the pins E, F, G and H jointly define a parallelogramic area. The first link 71 is provided with a second pivot seat 711.

In the present embodiment shown in the drawings, the first and second links 71, 72 are telescoped, so as to eliminate the risk of mutual interference therebetween in practical operation.

The damping mechanism 8 is composed of a damper 81 (that may be a gas cylinder with locking function) and a switch 82. The damper 81 is pivotally connected between the second pivot seat 711 of the first link 71 and the first pivot seat 523 of the loading component 5, and the damper 81 is connected to the switch 82 by means of a control cord 83. The switch 82 may be placed at one side of the second loading platform 62 and may have an operatable paddle 821. When the paddle 421 is operated, the switch 82 controls the damper 81 to allow it to extend or retract in response to an external force. When the paddle 821 is released, the damper 81 locks itself from extending and retracting.

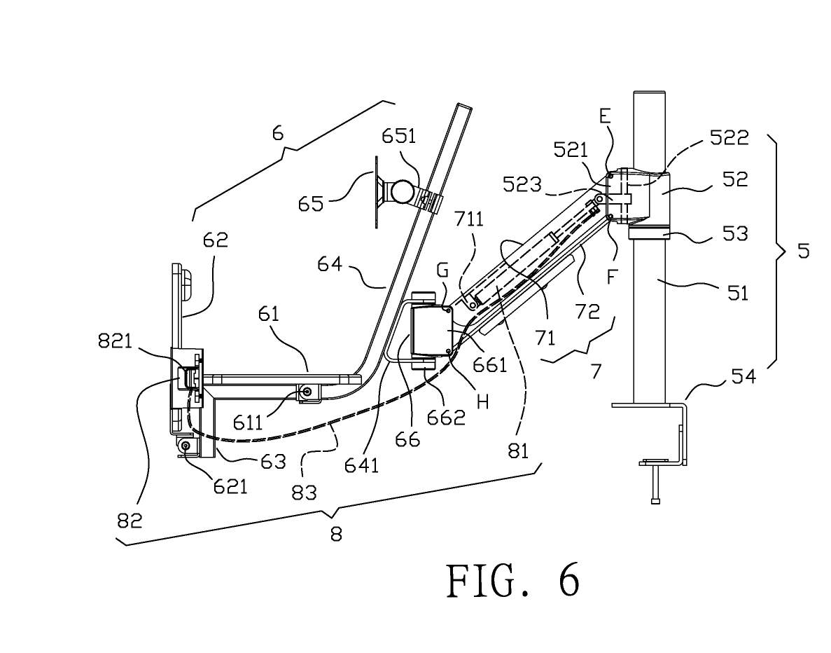

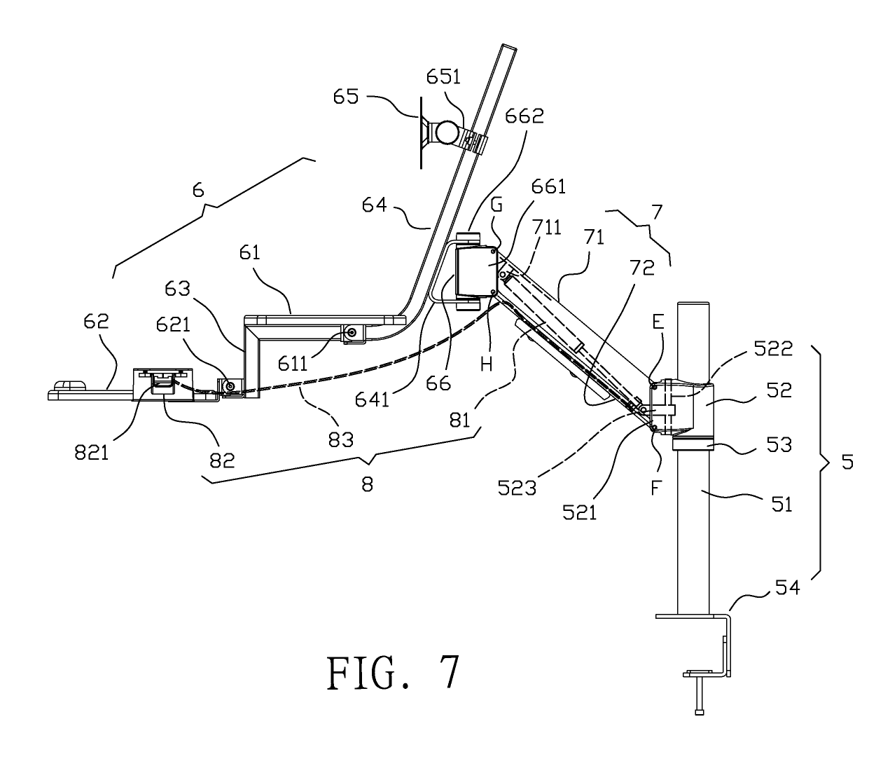

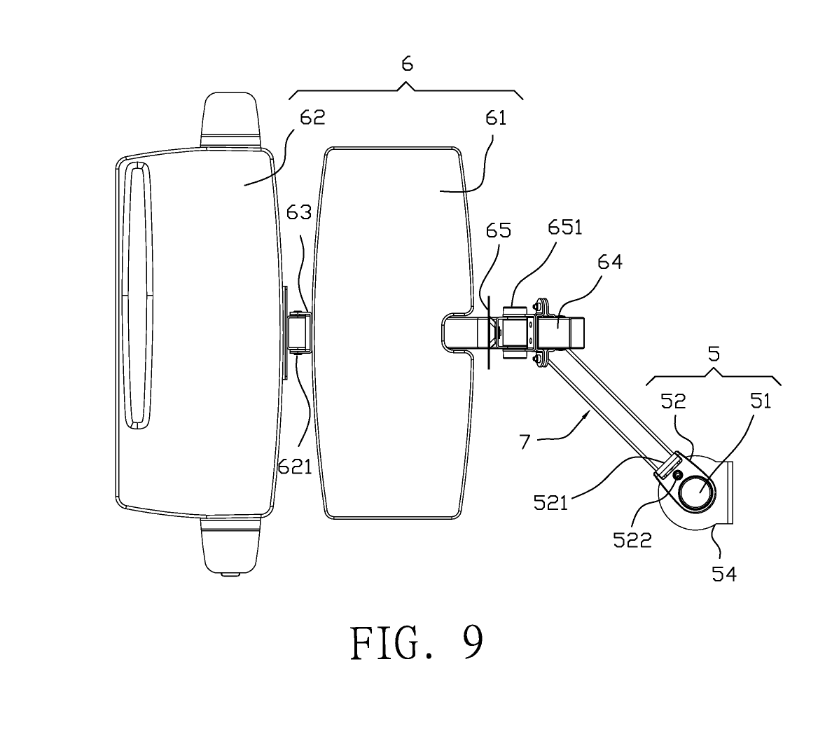

Referring to FIGS. 6, 7 and 9, according to the second embodiment of the present invention, during the positional adjustment, when the paddle 821 is operation, the second loading platform 62 can be pushed or pressed at the same time by an operator, so that the loading platform set 6 drives the first and second links 71, 72 to rotate relatively. Throughout the process of the rotation, the imaginary line connecting the pins G and H remains parallel to the imaginary line connecting the pins E and F (holding the parallelogramic area), so the loading platform set 6 is restricted to move forward/backward and upward/downward while remaining parallel to the loading component 5. With the pivotal movement of the first link 71, the damper 81 receives force and is driven to extend or retract.

When the loading platform set 6 moves to a desire position, the operator may release the paddle 821, so that the damper 81 is locked and prevented from extending and retracting, making the loading platform set 6 positioned. Thereby, even if the loading platform set 6 (the first and second loading platforms 61 and 62) receives external force (such as that from a user's palms pressing the second loading platform 62 when operating a keyboard placed on the second loading platform 22), it is unlikely to have unintentional displacement, making its use more convenient.

In practical use, the second loading platform 62 be folded by pivoting it upward on the second pivot 621 (as shown in FIG. 6), and the first loading platform 61 may also be folded by pivoting it upward on the first pivot 611 (not shown), thereby minimizing the space required for storing the collapsed structure.

In the process that the first and second loading platforms 61 and 62 are pushed to move leftward (or rightward), with the pivotable support 64 (i.e. the connector 641) that pivots with respect to the pivotal connector 66, and the revolver 52 that pivots with respect to the guiding post 51, the first and second loading platforms 61 and 62 can remain facing forward (its initial orientation) without deviating with the linkage 7, further improving the convenient use of the present invention.

To sum up, the disclosed self-positionable lifting device is effective in providing easy operation, reliable multi-direction control, and self-positioning after operation. The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A self-positionable lifting device, comprising:
a loading component, being locally provided with a joint;
a loading platform set, having a joint;
a linkage, including a first link and a second link that are parallel to each other, in which the first and second links each have one end pivotally connected to the joint of the loading component, and each have an opposite end pivotally connected to the joint of the loading platform set, so that pivotally connected points connecting the first link and the second link to the loading component and the loading platform set jointly define a parallelogramic area; and
a damping mechanism, including a damper and a switch, in which the damper is provided between the linkage and the loading component, and is connected to the switch via a control cord, so that when the switch is pushed, the damper is driven to extend or retract, and in turn makes the loading platform set horizontally move forward/backward and upward/downward with respect to the loading component in virtue of relative pivotal movements between the first and second links, and when the switch is released, the damper is prevented from extending or retracting.

2. The self-positionable lifting device of claim 1, wherein the loading component is provided with a first pivot seat, and the first link is provided with a second pivot seat, so that the damper has two ends thereof pivotally connected to the first and second pivot seats, respectively.

3. The self-positionable lifting device of claim 2, wherein the loading component is a base, and the first pivot seat is deposited on the base.

4. The self-positionable lifting device of claim 2, wherein the loading component includes a guiding post, a revolver, and a retainer, in which the revolver and the retainer are mounted around a middle part of the guiding post, while the retainer is located below the revolver, so that the revolver is retained at a predetermined altitude on the guiding post by the retainer and is allowed to freely pivot, and in which the first pivot seat is deposited on the revolver.

5. The self-positionable lifting device of claim 4, wherein the guiding post has one end thereof provided with a clamp that is configured to hold an external article or table and position the self-positionable lifting device with respect to the article or table.

6. The self-positionable lifting device of claim 4, wherein the loading platform set has a pivotal connector that is connected to both of the first and second links, and has a pivotable support, in which the pivotal connector has a pivotal shaft that is posed parallel to the guiding post, and the pivotable support has a connector is pivotally mounted around the pivotal shaft, so that by rotating the connector with respect to the pivotal shaft, the loading platform set is moved forward/backward, leftward/rightward and/or upward/downward respect to the loading component in a limited range.

7. The self-positionable lifting device of claim 6, wherein the pivotable support has a middle part thereof provided with an adjustable holder that is configured to move along and get positioned on the pivotable support, and a mount is pivotally connected to the adjustable holder.

8. The self-positionable lifting device of claim 1, wherein the loading platform set includes a first loading platform and a second loading platform that are mutually connected by an extension support.

9. The self-positionable lifting device of claim 8, wherein the switch is provided at one side of the second loading platform.

10. The self-positionable lifting device of claim 8, wherein the first and second loading platforms are parallel to each other and have an altitudinal difference therebetween.
